(19) United States
(12) Patent Application Publication
(10) Pub. No.: US 2025/0200879 A1
(43) Pub. Date: Jun. 19, 2025

(54) METHOD, DEVICE, AND COMPUTER PROGRAM FOR LOCALIZING AUTONOMOUS DRIVING VEHICLE USING LOW-CAPACITY NDT MAP

(71) Applicant: RideFlux Inc., Jeju-si (KR)

(72) Inventors: Hawook JEONG, Seoul (KR); Jiwoong KIM, Seoul (KR); Ho YUN, Jeju-si (KR); Gwanguk JUNG, Jeju-si (KR)

(73) Assignee: RideFlux Inc., Jeju-si (KR)

(21) Appl. No.: 19/069,991

(22) Filed: Mar. 4, 2025

Related U.S. Application Data
(63) Continuation of application No. PCT/KR2022/019882, filed on Dec. 8, 2022.

(30) Foreign Application Priority Data
Oct. 4, 2022 (KR) 10-2022-0125927

(51) Int. Cl. G06T 17/00

(52) U.S. Cl. CPC G06T 17/00

(57) ABSTRACT

Provided are a method, device, and recording medium for localizing an autonomous driving vehicle using a low-capacity NDT map. The method for localizing an autonomous driving vehicle using a low-capacity NDT map according to various embodiments of the present invention is executed by a computing device and may comprise the steps of: collecting 3D point clouds for a prescribed area; and localizing an autonomous driving vehicle using the collected 3D point clouds and a capacity normal distribution transform (NDT) map generated in correspondence with the prescribed area.

### CROSS-REFERENCE TO RELATED APPLICATIONS

The present application is a Continuation of International Application No. PCT/KR2022/019882 filed on Dec. 8, 2022, which is based upon and claims the benefit of priority to Korean Patent Application No. 10-2022-0125927 filed on Oct. 4, 2022, the entire contents of which are incorporated herein by reference.

### TECHNICAL FIELD

Various embodiments of the present invention relate to a method, device, and recording medium for localizing an autonomous driving vehicle using a low-capacity normal distribution transform (NDT) map.

### BACKGROUND ART

For the convenience of a user driving a vehicle, various sensors, electronic devices, and the like (e.g., an advanced driver assistance system (ADAS)) are being installed, and in particular, technology development for an autonomous driving system of a vehicle that recognizes the surrounding environment without driver intervention and automatically drives to a predetermined destination according to the recognized surrounding environment is being actively developed.

Here, an autonomous driving vehicle is a vehicle equipped with an autonomous driving system function that recognizes the surrounding environment without driver intervention and automatically drives to a predetermined destination according to the recognized surrounding environment.

The autonomous driving system performs localization, recognition, prediction, planning, and control for autonomous driving.

Here, localization is one autonomous driving element technology and refers to an operation of recognizing an accurate position and attitude of an autonomous driving vehicle. The autonomous driving system may secure safety and robustness for autonomous driving by performing localization on the autonomous driving vehicle using a map of a region where the autonomous driving vehicle will drive, and thus, in order to control a driving operation of the autonomous driving vehicle without driver intervention, it is necessary to produce a map of the region where the autonomous driving vehicle will drive in advance.

Here, the map that has been produced in advance for the region where the autonomous driving vehicle will drive is typically a digital map (e.g., road environment information that a computer can understand is stored in advance in the form of a database). In particular, a digital map for autonomous driving is referred to as a “precision map,” a “high definition (HD) map,” or a “highly automated driving (HAD) map.”

Conventionally, a three-dimensional (3D) point cloud map generated based on a 3D point cloud (e.g., a point cloud collected through a lidar, a radar, and a depth camera) has been used for such a digital map or precision map. However, there is a problem that it is difficult to use a map for a wide area because a data size of the 3D point cloud map is too large.

In order to overcome the problem of such a conventional digital map, NDT map data generated by modeling a 3D point cloud as a normal distribution set based on an NDT is used. However, when a driving area of an autonomous driving system is very wide, since a size of data of the 3D point cloud representing the driving area is also very large, there is a problem in that there is a limit to expanding the driving area because the size of NDT map data generated using the 3D point cloud data is bound to be large.

### DISCLOSURE

### Technical Problem

The present invention is directed to providing a method, a device, and a computer program for localizing an autonomous driving vehicle using a low-capacity NDT map that can efficiently compress a size of a map used for autonomous driving by generating the low-capacity NDT map, that is, a 2D NDT map rather than a 3D NDT map, using a 3D point cloud for a predetermined region, and is thereby capable of improving the scalability of an autonomous driving area.

The present invention is also directed to providing a method, a device, and a computer program for localizing an autonomous driving vehicle using a low-capacity NDT map that generates a 2D NDT map rather than a 3D NDT map as a low-capacity NDT map for a predetermined region, and enables reduction in an amount of computation compared to a method using a 3D NDT map by performing localization on an autonomous driving vehicle by matching the 2D NDT map with a 3D point cloud collected in real time, and is thereby capable of performing fast computation.

The present invention is also directed to providing a method, a device, and a computer program for localizing an autonomous driving vehicle using a low-capacity NDT map that generates a low-capacity NDT map for each object for a predetermined region and prevents interference, noise, and errors from occurring due to dynamic objects (e.g., nearby vehicles, pedestrians, etc.) located within a predetermined region by performing localization on the autonomous driving vehicle by matching the 3D point cloud collected in real time with the low-capacity NDT map for each object, and is thereby capable of improving localization performance for the autonomous driving vehicle.

Objects of the present invention are not limited to the objects mentioned above, and other objects that are not mentioned may be clearly understood by those skilled in the art from the description below.

### Technical Solution

According to an aspect of the present invention, there is provided a method of localizing an autonomous driving vehicle using a low-capacity normal distribution transform (NDT) map, which is performed by a computing device, the method including collecting a 3D point cloud for a predetermined region and performing localization on an autonomous driving vehicle using a previously generated low-capacity NDT map corresponding to the predetermined region and the collected 3D point cloud.

In various embodiments, the method may further include generating a plurality of grids by gridding the 3D point cloud corresponding to the predetermined region based on a two-dimensional plane, and modeling points one-to-one corresponding to the plurality of generated grids as a normal distribution and generating a 2D NDT map as a low-capacity NDT map for the predetermined region by storing information about the modeled normal distribution in each of the plurality of generated grids.

In various embodiments, the generating of the 2D NDT map may include extracting a plurality of first points corresponding to a road surface from among a plurality of points included in the 3D point cloud corresponding to the predetermined region, normalizing to normal distribution the extracted plurality of first points, and generating a road surface NDT map using the plurality of normalized first points, and extracting a plurality of second points corresponding to a fixed object from among the plurality of points included in the 3D point cloud corresponding to the predetermined region, normalizing to normal distribution the extracted plurality of second points, and generating a fixed object NDT map using the plurality of normalized second points.

In various embodiments, the generating of the fixed object NDT map may include determining a type of the fixed object located within the predetermined region based on a shape in which the plurality of extracted second points are distributed on a two-dimensional plane and classifying the plurality of extracted second points based on the determined type of the fixed object, and generating an NDT map for each fixed object using the plurality of classified second points.

In various embodiments, the classifying of the plurality of extracted second points may include classifying the plurality of extracted second points as second points distributed in a point shape, second points distributed in a line shape, or second points distributed in a surface shape, and the generating of the NDT map for each fixed object may include generating a first fixed object NDT map using the second points distributed in the point shape, generating a second fixed object NDT map using the second points distributed in the line point shape, and generating a third fixed object NDT map using the second points distributed in the surface shape.

In various embodiments, the generating of the 2D NDT map may further include storing the generated road surface NDT map, the generated first fixed object NDT map, the generated second fixed object NDT map, and the generated third fixed object NDT map in a form of a quad tree data structure.

In various embodiments, the generating of the 2D NDT map may include, for a first grid and a second grid disposed at a position adjacent to the first grid among the plurality of grids included in the generated 2D NDT map, merging the first grid and the second grid into one grid when a difference between a normal distribution before merging the first grid and the second grid and the normal distribution after merging the first grid and the second grid is less than or equal to a preset threshold value.

In various embodiments, the previously generated low-capacity NDT map may include a plurality of 2D NDT maps for the predetermined region, the plurality of 2D NDT maps including a road surface NDT map corresponding to a road surface and one or more fixed object NDT maps corresponding to the fixed object, and the performing of the localization on the autonomous driving vehicle may include selecting at least one 2D NDT map from among the plurality of 2D NDT maps based on a type of a localization value to be calculated for the autonomous driving vehicle, and calculating the localization value to be calculated by matching the selected at least one NDT map with the collected 3D point cloud.

In various embodiments, the one or more fixed object NDT maps may include a first fixed object NDT map corresponding to a first fixed object having a point shape, and the calculating of the localization value to be calculated may include matching the first fixed object NDT map with the collected 3D point cloud when the type of the localization value to be calculated is an x-axis coordinate value, a y-axis coordinate value, and a yaw value for the autonomous driving vehicle.

In various embodiments, the one or more fixed object NDT maps may include a second fixed object NDT map corresponding to a second fixed object having a line shape, and the calculating of the localization value to be calculated may include matching the second fixed object NDT map with the collected 3D point cloud when the type of the localization value to be calculated is a y-axis coordinate value and a yaw value or a z-axis coordinate value and a pitch value for the autonomous driving vehicle.

In various embodiments, the one or more fixed object NDT maps may include a third fixed object NDT map corresponding to a third fixed object having a surface shape, and the calculating of the localization value to be calculated may include matching the road surface NDT map or the third fixed object NDT map with the collected 3D point cloud when the type of the localization value to be calculated is a Z-axis coordinate value, a roll value, and a pitch value for the autonomous driving vehicle.

In various embodiments, the performing of the localization on the autonomous driving vehicle may include calculating a localization value for the autonomous driving vehicle by matching the 3D point cloud collected in real time from the autonomous driving vehicle located within the predetermined region with the previously generated low-capacity NDT map.

In various embodiments, the performing of the localization on the autonomous driving vehicle may include classifying a plurality of points included in the 3D point cloud collected in real time from the autonomous driving vehicle located within the predetermined region for each object, and calculating a localization value for the autonomous driving vehicle by the plurality of points classified for each object and each previously generated low-capacity NDT map.

In various embodiments, the performing of the localization on the autonomous driving vehicle may include generating a real-time 3D NDT map by normalizing to normal distribution the 3D point cloud collected in real time from the autonomous driving vehicle located within the predetermined region, and calculating a localization value for the autonomous driving vehicle by matching the generated real-time 3D NDT map with the previously generated low-capacity NDT map.

In various embodiments, the performing of the localization on the autonomous driving vehicle may include generating a plurality of grids by gridding the 3D point cloud collected in real time from the autonomous driving vehicle located within predetermined region based on a two-dimensional plane, modeling points one-to-one corresponding to the plurality of generated grids as a normal distribution, and generating a real-time 2D NDT map by storing information about the modeled normal distribution in each of the plurality of generated grids, and calculating a localization value for the autonomous driving vehicle by matching the generated real-time 2D NDT map with the previously generated low-capacity NDT map.

According to another aspect of the present invention, there is provided a computing device for performing a method of localizing an autonomous driving system using a low-capacity NDT map, the computing device including a processor, a network interface, a memory, and a computer program loaded into the memory and executed by the processor, in which the computer program includes an instruction for collecting a 3D point cloud for a predetermined region and an instruction for performing localization on an autonomous driving vehicle using a previously generated NDT map corresponding to the predetermined region and the collected 3D point cloud.

According to still another aspect of the present invention, there is a computing device-readable recording medium, on which a computer program coupled to the computing device to perform a method of localizing on an autonomous driving vehicle using a NDT map, the method including collecting a 3D point cloud for a predetermined region and performing localization on the autonomous driving vehicle using a previously generated NDT map corresponding to the predetermined region and the collected 3D point cloud.

Other specific details of the present invention are contained in the detailed description and drawings.

### Advantageous Effects

According to various embodiments of the present invention, there is an advantage in that the size of the map used for autonomous driving can be efficiently compressed by generating a low-capacity NDT map, that is, a 2D NDT map rather than a 3D NDT map, using a 3D point cloud for a predetermined region, and thereby the scalability of an autonomous driving area can be improved.

In addition, there is an advantage in that a 2D NDT map is generated as a low-capacity NDT map for a predetermined region rather than a 3D NDT map, and an amount of computation compared to a method using a 3D NDT map can be reduced by performing localization on an autonomous driving vehicle by matching the 2D NDT map with a 3D point cloud collected in real time, thereby performing fast computation.

In addition, there is an advantage in that a low-capacity NDT map for each object is generated for a predetermined area and interference, noise, and errors are prevented from occurring due to dynamic objects (e.g., nearby vehicles, pedestrians, etc.) located within a predetermined area by performing localization on the autonomous driving vehicle by matching the 3D point cloud collected in real time with the low-capacity NDT map for each object, and thereby localization performance for the autonomous driving vehicle can be improved.

The effects of the present invention are not limited to the effects mentioned above, and other effects that are not mentioned may be clearly understood by those skilled in the art from the description above.

### DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an autonomous driving system according to an embodiment of the present invention;

FIG. 2 is a hardware configuration diagram of a computing device for performing a method of localizing an autonomous driving vehicle using a low-capacity normal distribution transform (NDT) map according to another embodiment of the present invention;

FIG. 3 is a flowchart of a method of localizing an autonomous driving vehicle using a low-capacity NDT map according to another embodiment of the present invention;

FIG. 4 is a flowchart for describing a method of generating a low-capacity NDT map for a predetermined region according to various embodiments;

FIG. 5 is a flowchart illustrating a method of generating a low-capacity NDT map corresponding to a road surface and a fixed object according to various embodiments;

FIG. 6 is a diagram for describing a process of generating a low-capacity NDT map corresponding to a road surface and a fixed object from a 3D point cloud according to various embodiments;

FIG. 7 is a flowchart illustrating a method of generating a plurality of fixed object NDT maps based on a shape of a fixed object according to various embodiments; and

FIG. 8 is a diagram illustrating a localization value to be calculated for an autonomous driving vehicle according to various embodiments.

### MODES OF THE INVENTION

Various advantages and features of the present invention and methods accomplishing them will become apparent from the following description of embodiments with reference to the accompanying drawings. However, the present invention is not limited to embodiments to be described below, but may be implemented in various different forms, these embodiments will be provided only in order to make the present invention complete and allow those skilled in the art to completely recognize the scope of the present invention, and the present invention is defined solely by the scope of the claims.

Terms used in the present specification are for describing embodiments and are not intended to limit the present invention. Unless otherwise stated, a singular form includes a plural form in the present specification. “Comprise” and/or “comprising” as used in the specification does not exclude the presence or addition of one or more components other than the components stated. Like reference numerals refer to like components throughout the specification and “and/or” includes each of the components described and all combinations thereof. Although “first,” “second,” and the like are used to describe various components, it goes without saying that these components are not limited by these terms. These terms are used only to distinguish one component from other components. Therefore, it goes without saying that a first component described below may be a second component within the technical scope of the present invention.

Unless defined otherwise, all terms (including technical and scientific terms) used in the present specification may be used with meanings commonly understood by those skilled in the art to which the present invention pertains. In addition, terms defined in a commonly used dictionary are not ideally or excessively interpreted unless explicitly defined otherwise.

The term “unit” or “module” used herein means software or a hardware component such as a field programmable gate array (FPGA) or an application specific integrated circuit (ASIC) and the “unit” or “module” performs certain roles. However, the term “unit” or “module” is not meant to be limited to software or hardware. The “unit” or “module” may be stored in a storage medium that can be addressed or may be configured to execute one or more processors. Accordingly, as an example, the “unit” or “module” includes components such as software components, object-oriented software components, class components, and task components, processes, functions, attributes, procedures, subroutines, segments of a program code, drivers, firmware, a microcode, a circuit, data, a database, data structures, tables, arrays, and variables. Functions provided in components, “units,” or “modules” may be combined into fewer components, “units,” or “modules” or further separated into additional components, “units,” or “modules.”

Spatially relative terms “below,” “beneath,” “lower,” “above,” “upper,” and the like may be used to easily describe the correlation between one component and other components as illustrated in drawings. The spatially relative terms should be understood as terms including different directions of components during use or operation in addition to the directions illustrated in the drawings. For example, in a case in which a component illustrated in the drawings is turned over, a component described as “below” or “beneath” the component may be placed “above” the component. Therefore, the illustrative term “below” may include both downward and upward directions. The components may also be oriented in different directions, and therefore the spatially relative terms can be interpreted according to the orientation.

In this specification, the computer refers to all types of hardware devices including at least one processor and may be understood as including a software configuration which is operated in the corresponding hardware device according to an embodiment. For example, the computer may be understood as including a smart phone, a tablet personal computer (PC), a desktop, or a notebook, and user clients and applications running on each device, but is not limited thereto.

Hereinafter, embodiments of the present invention will be described in detail with reference to the accompanying drawings.

Each step described in the present specification is described as being performed by a computer, but subjects of each step are not limited thereto, and depending on the embodiment, at least some steps may also be performed by different devices.

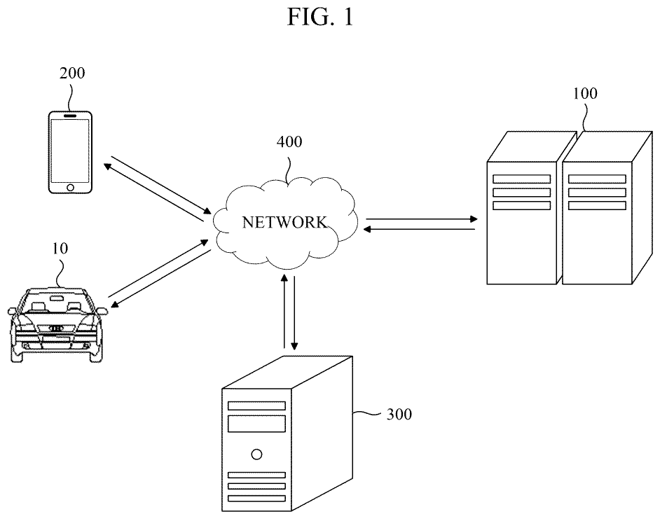

FIG. 1 is a diagram illustrating an autonomous driving system according to an embodiment of the present invention.

Referring to FIG. 1, the autonomous driving system according to the embodiment of the present invention may include a computing device 100, a user terminal 200, an external server 300, and a network 400.

Here, the autonomous driving system illustrated in FIG. 1 is according to an embodiment, and components of the autonomous driving system are not limited to the embodiment illustrated in FIG. 1, and some components may be added, changed, or omitted as necessary.

In an embodiment, the computing device 100 may perform various operations for autonomous driving control of an autonomous driving vehicle 10.

In various embodiments, the computing device 100 may perform a localizing operation of measuring a position and attitude of the autonomous driving vehicle 10 or a cognitive operation of recognizing the surrounding environment of the autonomous driving vehicle 10. For example, the computing device 100 may collect sensor data from a sensor (e.g., a lidar sensor, a radar sensor, a camera sensor, etc.) provided inside the autonomous driving vehicle 10, and may utilize the collected sensor data to measure the position and attitude of the autonomous driving vehicle 10 or recognize the surrounding environment of the autonomous driving vehicle 10.

In various embodiments, the computing device 100 generates an NDT map for a predetermined region, performs localization on the autonomous driving vehicle 10 by matching the NDT map with a 3D point cloud collected in real time from the predetermined region, and generates a low-capacity NDT map for the predetermined region, thereby ensuring scalability of a driving area in the autonomous driving system. A method of generating the low-capacity NDT map and a method of performing localization on the autonomous driving vehicle 10 using the low-capacity NDT map will be described in detail below.

In various embodiments, the computing device 100 may be connected to the user terminal 200 through the network 400, and the position and attitude of the autonomous driving vehicle 10 measured by analyzing sensor data, and various types of information related to autonomous driving such as the recognized surrounding environment and the generated low-capacity NDT map of the autonomous driving vehicle 10 may be provided to the user terminal 200.

Here, the user terminal 200 may be an infotainment system provided inside the vehicle 10 but is not limited thereto. The user terminal 200 is a wireless communication device that is guaranteed to be portable and mobile and may be a portable terminal that a passenger riding inside the vehicle 10 may carry. For example, examples of the user terminal 200 may include all types of handheld-based wireless communication devices such as a navigation device, a personal communication system (PCS), Global System for Mobile Communication (GSM), a personal digital cellular (PDC) phone, a personal handyphone system (PHS), a personal digital assistant (PDA), International Mobile Telecommunications (IMT)-2000, code division multiple access (CDMA)-2000, W-code division multiple access (W-CDMA), a wireless broadband Internet (WiBro) a terminal, a smart phone, a smart pad, and a tablet PC, but are not limited thereto.

In addition, here, the network 400 may be a connection structure capable of exchanging information between respective nodes such as a plurality of terminals and servers. For example, the network 400 may include a local area network (LAN), a wide area network (WAN), the Internet (World Wide Web (WWW)), a wired/wireless data communication network, a telephone network, a wired/wireless television communication network, and the like.

In addition, here, examples of the wireless data communication network may include 3G, 4G, 5G, 3^{rd} Generation Partnership Project (3GPP), 5^{th} Generation Partnership Project (5GPP), Long Term Evolution (LTE), World Interoperability for Microwave Access (WiMAX), Wi-Fi, the Internet, a local area network (LAN), a wireless local area network (WLAN), a wide area network (WAN), a personal area network (PAN), radio frequency (RF), a Bluetooth network, a near-field communication (NFC) network, a satellite broadcast network, an analog broadcast network, a digital multimedia broadcasting (DMB) network, and the like, but are not limited thereto.

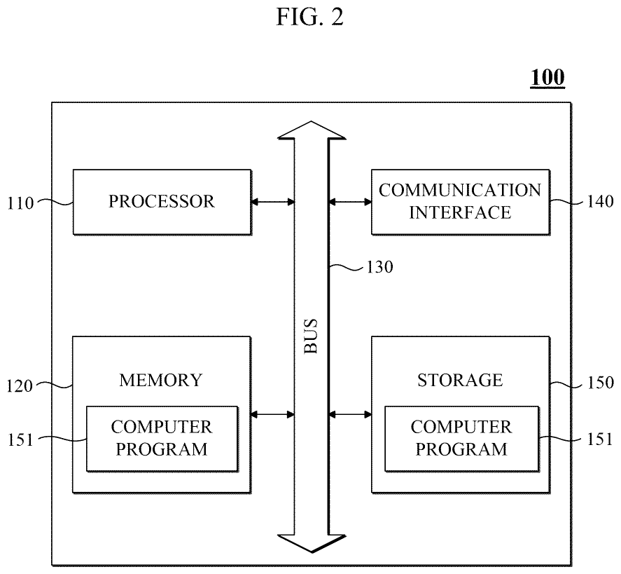

In an embodiment, the external server 300 may be connected to the computing device 100 via the network 400, and may store and manage various information and data required for the computing device 100 to perform the method of localizing the autonomous driving vehicle using the low-capacity NDT map, or may receive various information and data (e.g., a low-capacity NDT map for a predetermined region and the like) generated as the computing device 100 performs the method of localizing the autonomous driving vehicle using the low-capacity NDT map, and store and manage the various information and data. For example, the external server 300 may be a storage server separately provided outside the computing device 100 but is not limited thereto. Hereinafter, a hardware configuration of the computing device 100 for performing the method of localizing the autonomous driving vehicle using the low-capacity NDT map will be described with reference to FIG. 2.

FIG. 2 is a hardware configuration diagram of a computing device for performing a method of localizing an autonomous driving vehicle using a low-capacity NDT map according to another embodiment of the present invention.

Referring to FIG. 2, in various embodiments, the computing device 100 may include one or more processors 110, a memory 120 into which a computer program 151 executed by the processor 110 is loaded, a bus 130, a communication interface 140, and a storage 150 for storing the computer program 151. Here, only the components related to the embodiment of the present invention are illustrated in FIG. 2. Accordingly, those skilled in the art to which the present invention pertains may understand that general purpose components other than those illustrated in FIG. 2 may be further included.

The processor 110 controls an overall operation of respective components of the computing device 100. The processor 110 may include a central processing unit (CPU), a micro processor unit (MPU), a micro controller unit (MCU), a graphics processing unit (GPU), or any type of processor known in the art of the present invention.

In addition, the processor 110 may perform an operation on at least one application or program for executing the method according to the embodiments of the present invention, and the computing device 100 may include one or more processors.

In various embodiments, the processor 110 may further include a random access memory (RAM) (not illustrated) and a read-only memory (ROM) (not illustrated) for temporarily and/or permanently storing signals (or data) processed within the processor 110. In addition, the processor 110 may be implemented in the form of a system-on-chip (SoC) including at least one of the GPU, the RAM, and the ROM.

The memory 120 stores various types of data, commands and/or information. The memory 120 may load the computer program 151 from the storage 150 to execute methods/operations according to various embodiments of the present invention. When the computer program 151 is loaded into the memory 120, the processor 110 may perform the method/operation by executing one or more instructions constituting the computer program 151. The memory 120 may be implemented as a volatile memory such as a RAM, but the technical scope of the present disclosure is not limited thereto.

The bus 130 provides a communication function between the components of the computing device 100. The bus 130 may be implemented as various types of buses, such as an address bus, a data bus, and a control bus.

The communication interface 140 supports wired/wireless Internet communication of the computing device 100. In addition, the communication interface 140 may support various communication methods other than the Internet communication. To this end, the communication interface 140 may include a communication module known in the art of the present invention. In some embodiments, the communication interface 140 may be omitted.

The storage 150 may non-temporarily store the computer program 151. When a process of localizing an autonomous driving vehicle using a low-capacity NDT map through the computing device 100 is performed, the storage 150 may store various types of information necessary to provide the process of localizing the autonomous driving vehicle using the low-capacity NDT map.

The storage 150 may include a nonvolatile memory, such as a ROM, an erasable programmable ROM (EPROM), an electrically erasable programmable ROM (EEPROM), and a flash memory, a hard disk, a removable disk, or any type of computer-readable recording medium known in the art to which the present invention pertains.

The computer program 151 may include one or more instructions to cause the processor 110 to perform methods/operations according to various embodiments of the present invention when loaded into the memory 120. That is, the processor 110 may perform the method/operation according to various embodiments of the present invention by executing the one or more instructions.

In an embodiment, the computer program 151 may include one or more instructions for causing a method of localizing an autonomous driving vehicle using a low-capacity NDT map to be performed, the method including collecting a 3D point cloud for a predetermined region and calculating a localization value for the autonomous driving vehicle using a previously generated low-capacity NDT map corresponding to the predetermined region and the collected 3D point cloud

Operations of the method or algorithm described with reference to the embodiment of the present invention may be directly implemented in hardware, in a software module executed by hardware, or in a combination thereof. The software module may reside in a RAM, a ROM, an EPROM, an EEPROM, a flash memory, a hard disk, a removable disk, a compact disc read-only memory (CD-ROM), or any form of computer-readable recording medium known in the art to which the invention pertains.

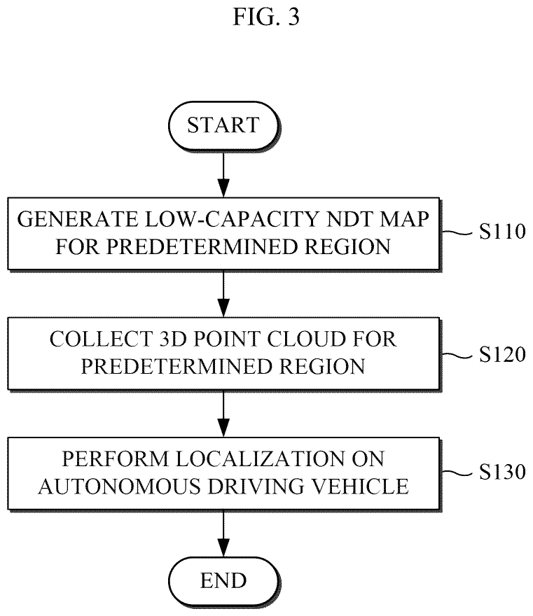

The components of the present invention may be implemented as a program (or application) to be executed by being combined with a computer which is hardware and stored in a medium. The components of the present invention may be executed in software programming or by software elements, and similarly, embodiments may be implemented by a programming or scripting language such as C, C++, Java, or an assembler, including various algorithms implemented in a combination of data structures, processes, routines, or other programming constructions. Functional aspects may be implemented in algorithms executed on one or more processors. Hereinafter, the method of localizing the autonomous driving vehicle using the low-capacity NDT map performed by the computing device 100 will be described with reference to FIGS. 3 to 8.

FIG. 3 is a flowchart of a method of localizing an autonomous driving vehicle using a low-capacity NDT according to another embodiment of the present invention.

Referring to FIG. 3, in operation S110, the computing device 100 may generate a low-capacity NDT map corresponding to a predetermined region for the purpose of performing localization on the autonomous driving vehicle 10 located within the predetermined region.

Here, the low-capacity NDT map according to various embodiments of the present invention may be an NDT map having a smaller capacity than the NDT map typically used in an autonomous driving system, for the purpose of improving the scalability of the autonomous driving area. For example, the low-capacity NDT map may be a 2D NDT map in which normal distribution information is stored in a two-dimensional grid, rather than a 3D NDT map in which normal distribution information is stored in a three-dimensional voxel by modeling a 3D point cloud as a normal distribution.

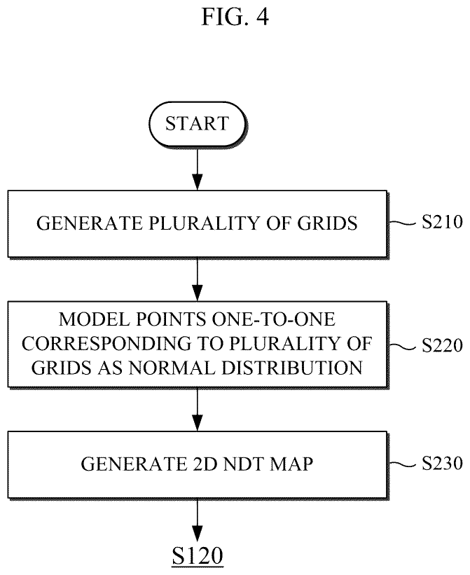

Meanwhile, the low-capacity NDT map according to various embodiments of the present invention may be expressed as a 2D NDT map because the low-capacity NDT map has a shape in which normal distribution information is stored in a grid on a two-dimensional plane, but in some cases, not only information about the normal distribution but also elevation information (e.g., Z-axis coordinate value) about a plurality of points is stored in each of the plurality of grids, and thus the low-capacity NDT map may be expressed as a 2.5D NDT map. Hereinafter, with reference to FIG. 4, the method of generating the low-capacity NDT map performed by the computing device 100 will be described in more detail.

FIG. 4 is a flowchart for describing a method of generating a low-capacity NDT map for a predetermined region according to various embodiments.

Referring to FIG. 4, in operation S210, the computing device 100 may generate a plurality of grids by gridding a 3D point cloud corresponding to a predetermined area based on a two-dimensional plane.

In various embodiments, the computing device 100 may collect a 3D point cloud for a predetermined region through sensors (e.g., a lidar, a radar, a depth camera) equipped in the autonomous driving vehicle 10 located within the predetermined region for the purpose of generating a low-capacity NDT map for the predetermined region, and may generate a plurality of grids by gridding the collected 3D point cloud based on the XY plane.

Here, the plurality of grids may have squares of the same size (e.g., 10 cm×10 cm or 2 cm×2 cm, etc.), but are not limited thereto, and the plurality of grids may have different sizes or various shapes such as rectangles.

In operation S220, the computing device 100 may model points one-to-one corresponding to the plurality of grids generated in operation S210 as a normal distribution.

In various embodiments, the computing device 100 may model points located within each of the plurality of grids as the normal distribution, that is, convert points located within each of the plurality of grids into a Gaussian probability distribution set. For example, the computing device 100 may generate a normal distribution corresponding to each of the plurality of grids by making a mean value and covariance matrix of points located within each of the plurality of normalized to normal distribution grids.

In operation S230, the computing device 100 may generate a 2D NDT map as a low-capacity NDT map for a predetermined region using the plurality of normal distributions generated in operation S220.

In various embodiments, the computing device 100 may generate a 2D NDT map by storing information about the normal distribution generated by modeling points one-to-one corresponding to the plurality of grids as a normal distribution in each of the plurality of grids.

Normally, since there are objects of different shapes such as road surfaces, street trees, streetlights, guardrails, curbs, building walls, roofs, etc. in a predetermined region, when generating one NDT map corresponding to the predetermined region, the form of the normal distribution included in the NDT map is not constant and is generated in various ways due to these various objects, and thus there is a problem that it is difficult to compress the NDT map any further.

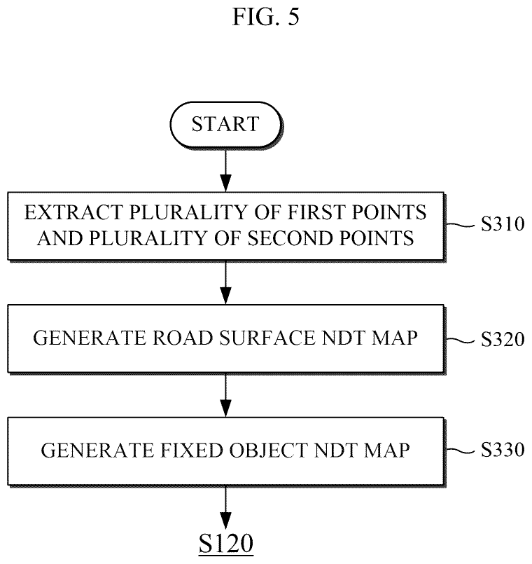

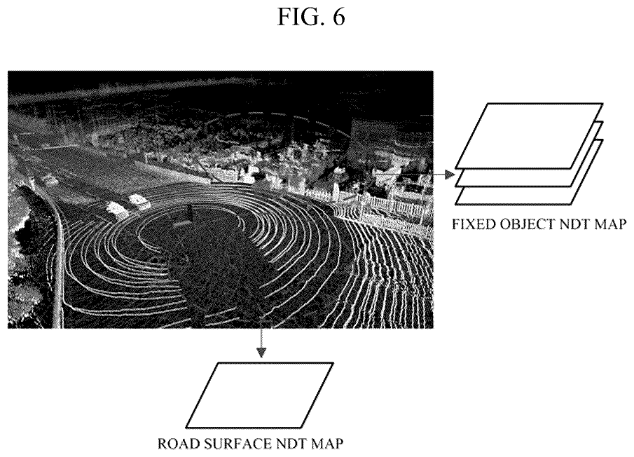

In consideration of these matters, the computing device 100 may individually generate the low-capacity NDT map for each road surface and fixed object (e.g., a fixed structure such as a street tree, streetlight, curb, guardrail, building, etc.) within a predetermined region. Hereinafter, a more detailed description will be made with reference to FIGS. 5 and 6.

FIG. 5 is a flowchart illustrating a method of generating a low-capacity NDT map corresponding to a road surface and a fixed object according to various embodiments and FIG. 6 is a diagram for describing a process of generating a low-capacity NDT map corresponding to a road surface and a fixed object from a 3D point cloud according to various embodiments.

Referring to FIGS. 5 and 6, in various embodiments, the computing device 100 may individually generate a road surface NDT map corresponding to a road surface and a fixed object NDT map corresponding to a fixed object as the low-capacity NDT map for a predetermined region.

In operation S310, the computing device 100 may extract a plurality of first points corresponding to the road surface and a plurality of second points corresponding to the fixed object from among a plurality of points included in a 3D point cloud corresponding to a predetermined region.

In various embodiments, the computing device 100 may identify the road surface and the fixed object included in the 3D point cloud by analyzing the 3D point cloud corresponding to the predetermined region using a pre-trained artificial intelligence model, and may classify the plurality of points included in the 3D point cloud as a plurality of first points corresponding to the road surface and a plurality of second points corresponding to the fixed object based on the identification result.

Here, the pre-trained artificial intelligence model may be a model that is trained using a 3D point cloud labeled with information about the road surface and the object as training data, and may be a model that outputs as result data a result of identifying the road surface and the fixed object included in the input 3D point cloud using the 3D point cloud as input data.

An artificial intelligence model (e.g., a neural network) is composed of one or more network functions, and one or more network functions may be generally composed of a set of interconnected computation units, which may be referred to as “nodes.” These “nodes” may be referred to as “neurons.” The one or more network functions include at least one or more nodes. Nodes (or neurons) constituting one or more network functions may be interconnected by one or more “links.”

Within the artificial intelligence model, one or more nodes connected through a link may form a relationship between an input node and an output node. The concept of the input node and the output node is relative, and any node in an output node relationship with one node may be in an input node relationship with another node, and vice versa. As described above, the input node to output node relationship may be generated around a link. One or more output nodes may be connected to one input node through the link, and vice versa.

In the relationship between the input node and the output node connected through one link, a value of the output node may be determined based on data input to the input node. Here, a node interconnecting the input node and the output node may have a weight. The weight may be variable and may be varied by a user or algorithm to enable the artificial intelligence model to perform the desired function. For example, when one or more input nodes are connected to one output node by respective links, the output node may determine an output node value based on values input to input nodes connected to the output node and a weight set in a link corresponding to each of the input nodes.

As described above, the artificial intelligence model is one in which one or more nodes are interconnected via one or more links to form an input node and output node relationship within the artificial intelligence model. The characteristics of the artificial intelligence model may be determined according to the number of nodes and links, the correlation between the nodes and the links, and the value of the weight assigned to each link within the artificial intelligence model. For example, when there are two artificial intelligence models where the same number of nodes and links are present and the weight values between the links are different, the two artificial intelligence models may be recognized as being different from each other.

Some of the nodes constituting the artificial intelligence model may constitute one layer based on distances from an initial input node. For example, a set of nodes that are at a distance n from the initial input node may constitute an n layer. The distance from the initial input node may be defined by the minimum number of links that should be passed to reach the corresponding node from the initial input node. However, this definition of the layer is arbitrary for the purpose of description, and the order of the layers in the artificial intelligence model may be defined in a different way from that described above. For example, a layer of nodes may be defined by a distance from the final output node.

The initial input node may be one or more nodes to which data is directly input without passing through a link in relationship with other nodes among the nodes within an artificial intelligence model. Alternatively, in a relationship between nodes based on the link within the artificial intelligence model network, the initial input node may be nodes that do not have other input nodes connected through links. Similarly, a final output node may be one or more nodes that do not have an output node in a relationship with other nodes among the nodes within the artificial intelligence model. In addition, hidden nodes may be nodes constituting the artificial intelligence model other than the initial input node and the final output node. The artificial intelligence model according to an embodiment of the present invention may be an artificial intelligence model in which the number of nodes in an input layer may be greater than that in a hidden layer close to an output layer, and the number of nodes decreases as it progresses from the input layer to the hidden layer.

The artificial intelligence model may include one or more hidden layers. A hidden node of the hidden layer may receive an output of the previous layer and an output of a neighboring hidden node as an input. The number of hidden nodes for each hidden layer may be the same or different. The number of nodes in the input layer may be determined based on the number of data fields of the input data and may be the same as or different from the number of hidden nodes. Input data input to the input layer may be computed by the hidden node of the hidden layer and may be output by a fully connected layer (FCL) which is an output layer.

In various embodiments, the artificial intelligence model may be a deep learning model.

The deep learning model (e.g., a deep neural network (DNN)) may be an artificial intelligence model including a plurality of hidden layers in addition to an input layer and an output layer. A deep neural network may be used to ascertain latent structures of data. That is, it is possible to ascertain latent structures (e.g., objects in a photo, content and emotion of the text, content and emotion of the voice, etc.) of the photo, the text, the video, the voice, and the music.

The deep neural network may include, but is not limited to, a convolutional neural network (CNN), a recurrent neural network (RNN), an auto encoder, a generative adversarial network (GAN), a restricted Boltzmann machine (RBM), a deep belief network (DBN), a Q network, a U network, a Siamese network, and the like.

In various embodiments, the network function may include an auto encoder. Here, the auto encoder may be a kind of artificial neural network for outputting output data similar to input data.

The auto encoder may include at least one hidden layer, and an odd number of hidden layers may be disposed between input and output layers. The number of nodes in each layer may be reduced from the number of nodes in the input layer to an intermediate layer called a bottleneck layer (encoding) and then expanded symmetrically with the reduction from the bottleneck layer to an output layer (symmetrical to the input layer). Nodes in the dimension reduction layer and the dimension restoration layer may or may not be symmetric. In addition, the auto encoder may perform a nonlinear dimension reduction. The number of input layers and the number of output layers may correspond to the number of sensors remaining after preprocessing of input data. In an auto encoder structure, the number of nodes in the hidden layer included in the encoder may have a structure that decreases as the distance from the input layer increases. The number of nodes in the bottleneck layer (the layer having the fewest nodes located between the encoder and the decoder) may be maintained at a certain number or more (e.g., half or more of the number of nodes in the input layer, etc.) because a sufficient amount of information may not be transmitted when the number of nodes in the bottleneck layer is too small.

A neural network may be trained using at least one of supervised learning, unsupervised learning, and semi-supervised learning. Training of the neural network is for minimizing an error of an output. More specifically, the training of the neural network is a process of repeatedly inputting training data to the neural network, computing an error between output of the neural network for the training data and a target, backpropagating the error of the neural network in a direction from the output layer to the input layer of the neural network in a direction for reducing the error, and updating a weight of each node of the neural network.

First, in the case of the supervised learning, training data with a correct answer labeled (i.e., labeled training data) is used for each piece of training data, and in the case of unsupervised learning, each piece of training data may not be labeled with a correct answer. That is, for example, training data in the case of supervised learning related to data classification may be data in which each piece of training data may be labeled with a category. The labeled training data is input to the neural network, and an error may be computed by comparing the output (category) of the neural network with the label of the training data.

Next, in the case of the unsupervised learning for the data classification, an error may be computed by comparing training data, which is an input, with an output of the neural network. The computed error may be backpropagated in the neural network in the backward direction (i.e., the direction from the input layer to the output layer), and a connection weight of each node in each layer of the neural network may be updated according to the backpropagation. A change amount in the connection weight of each node to be updated may be determined according to a learning rate. The computation in the neural network for the input data and the backpropagation of the error may constitute a training cycle (epoch). The learning rate can be applied differently depending on the number of iterations) of the training cycle of the neural network. For example, in the early stages of training the neural network, a high learning rate may be used to allow the neural network to quickly achieve a certain level of performance to increase efficiency, and in the later stages of the training, a low learning rate may be used to increase accuracy.

In the training of the neural network, training data may be a subset of actual data (that is, data to be processed using a trained neural network), and thus there may be a training cycle in which errors in the training data decrease but errors in actual data increase. Overfitting is a phenomenon in which errors in actual data increase due to excessive learning on the training data. For example, a phenomenon in which a neural network that has learned a cat by being shown orange cats fails to recognize a cat when it sees a non-orange cat may be a type of overfitting. Overfitting may act as a factor that increases errors in machine learning algorithms. To prevent such overfitting, various optimization methods may be used. In order to prevent overfitting, methods such as increasing training data, regularization, or dropout, which involves dropping out some nodes in the network during training, may be adopted.

In operation S320, the computing device 100 may generate a road surface NDT map corresponding to the road surface using the plurality of first points extracted in operation S310. Here, a method of generating the road surface NDT map may be implemented in the same form as or a similar form to the method of generating the low-capacity NDT map according to FIG. 4, but is not limited thereto.

For example, the computing device 100 may extract a plurality of first points from a 3D point cloud corresponding to a predetermined region, generate a plurality of grids by gridding the extracted plurality of first points based on a two-dimensional plane, model the first points one-to-one corresponding to the plurality of grids as a normal distribution, and generate a two-dimensional (or 2.5-dimensional) road surface NDT map by storing information about the first points modeled as the normal distribution in each of the plurality of grids.

In operation S330, the computing device 100 may generate a fixed object NDT map corresponding to the fixed object using the plurality of second points extracted in operation S310. Here, a method of generating the fixed object NDT map may be implemented in the same form as or a similar form to the method of generating the low-capacity NDT map according to FIG. 4, but is not limited thereto.

For example, the computing device 100 may extract a plurality of second points from a 3D point cloud corresponding to a predetermined region, generate a plurality of grids by gridding the extracted plurality of second points based on a two-dimensional plane, model the second points one-to-one corresponding to the plurality of grids as a normal distribution, and generate a two-dimensional (or 2.5-dimensional) fixed object NDT map by storing information about the second points modeled as the normal distribution in each of the plurality of grids.

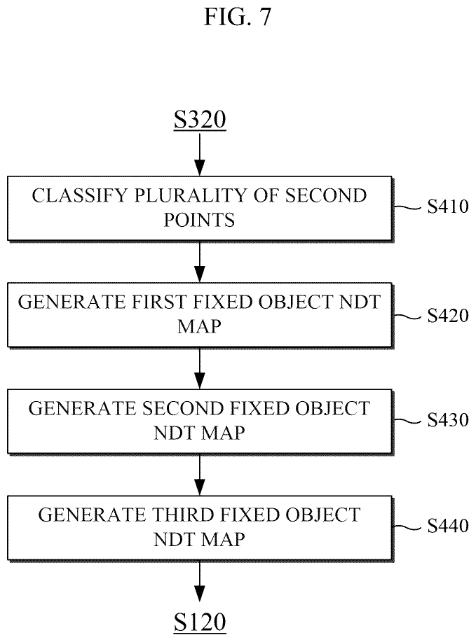

FIG. 7 is a flowchart illustrating a method of generating a plurality of fixed object NDT maps based on a shape of a fixed object according to various embodiments.

Referring to FIG. 7, in various embodiments, the computing device 100 may generate an NDT map for each fixed object type for a predetermined region.

In operation S410, the computing device 100 may classify the plurality of second points extracted from the 3D point cloud based on a type of the fixed object located within the predetermined region.

In various embodiments, the computing device 100 may determine the type of the fixed object based on a shape in which the plurality of second points are distributed on a two-dimensional plane, and classify the plurality of second points based on the determined type of the fixed object.

For example, the computing device 100 may classify second points distributed in a point shape among a plurality of second points as second points corresponding to a first fixed object (e.g., a fixed object having a point shape based on an XY plane, such as a street tree, a street light, etc.) based on a shape in which the plurality of second points are distributed on the XY plane. In addition, the computing device 100 may classify second points distributed in a line shape among the plurality of second points as second points corresponding to a second fixed object (e.g., a fixed object having a line shape based on an XY plane, such as a guard-rail, a curb, a wall surface of a building, etc.). In addition, the computing device 100 may classify second points distributed in a surface shape among the plurality of second points as second points corresponding to a third fixed object (e.g., a fixed object having a surface shape based on an XY plane such as a roof of a building).

Here, although it is described that the computing device 100 classifies the plurality of second points as second points distributed in the shape of a point, a line, and a surface based on the type of the fixed object, this is merely an example for more easily describing a process of classifying the plurality of second points according to the type of the fixed object, and is not limiting. Since fixed objects may have various shapes such as circles, ellipses, polygons, and the like as well as point, line, and surface shapes, the computing device 100 may classify the plurality of second points in consideration of fixed objects having various shapes. For example, the computing device 100 may classify each of the second points distributed in a circular shape, the second points distributed in an elliptical shape, the second points distributed in a polygonal shape, and the second points distributed in a broken line shape as second points corresponding to a different fixed object, based on the shape in which the plurality of second points are distributed on the XY plane.

In operation S420, the computing device 100 may generate a first fixed object NDT map using the second point corresponding to the first fixed object, that is, the second points distributed in the point shape. Here, a method of generating the first fixed object NDT map may be implemented in the same form as or a similar form to the method of generating the low-capacity NDT map according to FIG. 4 but is not limited thereto.

For example, the computing device 100 may generate a plurality of grids by gridding the second points distributed in the point shape based on a two-dimensional plane, model the second points one-to-one corresponding to the plurality of grids as a normal distribution, and generate a first fixed object NDT map in a two-dimensional (or 2.5-dimensional) shape, that is, an NDT map corresponding to the first fixed object having a point shape, such as a street tree or a street light, by storing the information about the second points modeled as the normal distribution in each of the plurality of grids.

In operation S430, the computing device 100 may generate a second fixed object NDT map using the second point corresponding to the second fixed object, that is, the second points distributed in the line shape. Here, a method of generating the second fixed object NDT map may be implemented in the same form as or a similar form to the method of generating the low-capacity NDT map according to FIG. 4 but is not limited thereto.

For example, the computing device 100 may generate a plurality of grids by gridding the second points distributed in the line shape based on a two-dimensional plane, model the second points one-to-one corresponding to the plurality of grids as a normal distribution, and generate a second fixed object NDT map in a two-dimensional (or 2.5-dimensional) shape, that is, an NDT map corresponding to the second fixed object having the line shape, such as a guard-rail, a curb, and a wall surface of a building, by storing the information about the second points modeled as the normal distribution in each of the plurality of grids.

In operation S440, the computing device 100 may generate a third fixed object NDT map using the second point corresponding to the third fixed object, that is, the second points distributed in the surface shape. Here, a method of generating the third fixed object NDT map may be implemented in the same form as or a similar form to the low-capacity NDT map generation method according to FIG. 4 but is not limited thereto.

For example, the computing device 100 may generate a plurality of grids by gridding the second points distributed in the surface shape based on a two-dimensional plane, model the second points one-to-one corresponding to the plurality of grids as a normal distribution, and generate a third fixed object NDT map in a two-dimensional (or 2.5-dimensional) shape, that is, an NDT map corresponding to the third fixed object having the surface shape, such as a roof of a building.

In various embodiments, the computing device 100 may store a plurality of 2D NDT maps (e.g., a road surface NDT map, a first fixed object NDT map, a second fixed object NDT map, and a third fixed object NDT map) generated as low-capacity NDT maps for a predetermined region according to a two-dimensional data structure. For example, the computing device 100 may store the road surface NDT map, the first fixed object NDT map, the second fixed object NDT map, and the third fixed object NDT map in the form of a quadtree data structure but is not limited thereto.

Since a predetermined region where the autonomous driving vehicle 10 drives is a three-dimensional space, a three-dimensional data structure is required to strictly express the predetermined region. Meanwhile, since the two-dimensional data structure is advantageous in terms of data size or access speed compared to a three-dimensional data structure, it is more effective to store the data in the two-dimensional data structure.

However, when generating a 3D NDT map for a predetermined region using a 3D point cloud corresponding to the predetermined region, since normal distributions corresponding to the road surface and the fixed objects located within the predetermined region are mixed, it is difficult to store the 3D NDT map in a two-dimensional data structure for data compression, and even when storing the 3D NDT map in the two-dimensional data structure, the loss of information is large and is not effective, which is problematic.

In contrast, as described above, when generating a plurality of 2D NDT maps (e.g., road surface NDT maps corresponding to road surfaces and first to third fixed object NDT maps corresponding to fixed objects) separately for a predetermined region, since the normal distributions corresponding to objects located within the predetermined region are not mixed, the complexity of the map can be reduced, information contained in each 2D NDT map has regularity, and thus it is easy to store the information in a two-dimensional data structure such as a quadtree, and the compression effect of a low-capacity NDT map for a predetermined region can be increased.

In various embodiments, the computing device 100 may further enhance the compression effect on the 2D NDT map by merging the normal distributions having similar shapes to each other. For example, the computing device 100 may merge adjacent grids into one grid when a difference between the normal distribution before merging adjacent grids and the normal distribution after merging the adjacent grids among a plurality of grids included in the 2D NDT map (e.g., the road surface NDT map and first to third fixed object NDT maps) is less than or equal to a preset threshold value.

For example, the computing device 100 may merge the first grid and the second grid into one grid when a value obtained by integrating a normal distribution probability density function value before merging a first grid and a second grid (e.g., a grid disposed at a position adjacent to the first grid) among the plurality of grids included in the 2D NDT map and a normal distribution probability density function value after merging the first grid and the second grid is less than or equal to a preset threshold value.

As described above, since various types of objects are present in a predetermined region, when one NDT map corresponding to the predetermined region is generated, the form of the normal distribution included in the NDT map is not constant and is generated in various ways due to various objects located within the predetermined region, and thus there is a problem that it is difficult to compress the NDT map any further.

In contrast, as in the case of the low-capacity NDT map according to various embodiments of the present invention, instead of generating one NDT map for a predetermined region, when the NDT map is generated by dividing the NDT map into the road surface NDT map corresponding to the road surface and the fixed object NDT map corresponding to the fixed object, and the fixed object NDT map is also generated, according to the type of the fixed object, by dividing the fixed object NDT map into the first fixed object NDT map corresponding to the first fixed object having a point shape, the second fixed object NDT map corresponding to the second fixed object having a line shape, and the third fixed object NDT map corresponding to the third fixed object having a surface shape, NDT maps having similar normal distributions can be generated, and accordingly, similar normal distributions disposed in adjacent locations can be merged more effectively, and thus the compression effect on the NDT map corresponding to a predetermined region can be increased.

Referring back to FIG. 3, in operation S120, the computing device 100 may collect the 3D point cloud for the predetermined region for the purpose of performing localization on the autonomous driving vehicle 10 located within a predetermined region.

For example, the computing device 100 may obtain a 3D point cloud collected by scanning a predetermined region through sensors (e.g., a lidar, a radar, a depth camera, etc.) equipped in the autonomous driving vehicle 10 by the autonomous driving vehicle 10 located within the predetermined region, but is not limited thereto.

In operation S130, the computing device 100 may perform localization on the autonomous driving vehicle 10 using the low-capacity NDT map for the predetermined region generated in operation S110 and the 3D point cloud collected in operation S120.

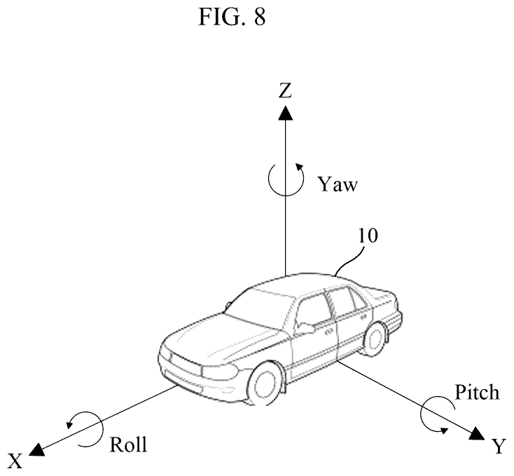

Here, performing the localization on the autonomous driving vehicle 10 may include measuring six degrees of freedom for the autonomous driving vehicle 10, for example, measuring a position (e.g., an X-axis coordinate value, a Y-axis coordinate value, and a Z-axis coordinate value) and an attitude (e.g., roll, pitch, and yaw values) of the autonomous driving vehicle 10, as illustrated in FIG. 8, but is not limited thereto.

In various embodiments, the computing device 100 may perform localization on the autonomous driving vehicle 10 by matching a 3D point cloud collected from the autonomous driving vehicle 10 with a plurality of 2D NDT maps, which are low-capacity NDT maps corresponding to a predetermined region, select at least one 2D NDT map among the plurality of 2D NDT maps based on the type of a localization value to be calculated for the autonomous driving vehicle 10, and calculate the localization value by matching the selected at least one NDT map with the 3D point cloud.

As an example, when the type of localization value to be calculated for the autonomous driving vehicle 10 is the Z-axis coordinate value, roll value, and pitch value for the autonomous driving vehicle 10, the computing device 100 may calculate the Z-axis coordinate value, roll value, and pitch value for the autonomous driving vehicle 10 by matching the road surface NDT map or the third fixed object NDT map among a plurality of 2D NDT maps with the 3D point cloud.

As another example, when the type of localization value to be calculated for the autonomous driving vehicle 10 is the X-axis coordinate value, Y-axis coordinate value, and yaw value for the autonomous driving vehicle 10, the computing device 100 may calculate the X-axis coordinate value, Y-axis coordinate value, and yaw value for the autonomous driving vehicle 10 by matching the first fixed object NDT map with the 3D point cloud.

As still another example, when the type of localization value to be calculated for the autonomous driving vehicle 10 is the Y-axis coordinate value and yaw value or the Z-axis coordinate value and pitch value for the autonomous driving vehicle 10, the computing device 100 may calculate the computing device 100 may calculate the X-axis coordinate value, Y-axis coordinate value, and yaw value for the autonomous driving vehicle 10 by matching the first fixed object NDT map with the 3D point cloud.

In various embodiments, the computing device 100 may perform localization on the autonomous driving vehicle 10 according to a point to distribution (P2D) method.

Here, the P2D method may be a method of matching a point cloud with an NDT map by comparing a point cloud with the NDT map expressed as a normal distribution set.

As an example, the computing device 100 may perform localization on the autonomous driving vehicle 10 by matching a plurality of points included in a 3D point cloud collected in real time from the autonomous driving vehicle 10 located within a predetermined region with a previously generated low-capacity NDT map for the predetermined region through the P2D method.

As another example, the computing device 100 may classify a plurality of points included in the 3D point cloud collected in real time from the autonomous driving vehicle 10 located within a predetermined region according to a type of the object, and perform localization on the autonomous driving vehicle 10 by matching the plurality of points classified according to the type of the object and each of the previously generated low-capacity NDT maps through the P2D method.

For example, the computing device 100 may extract points corresponding to the road surface from the 3D point cloud collected in real time and perform localization on the autonomous driving vehicle 10 by matching points corresponding to the road surface with the road surface NDT map. In addition, the computing device 100 may extract points one-to-one corresponding to the first to third fixed objects from the 3D point cloud collected in real time and perform localization on the autonomous driving vehicle 10 by matching the points one-to-one corresponding to the first to third fixed objects with each of the first to third fixed object NDT maps.

In various embodiments, the computing device 100 may perform localization on the autonomous driving vehicle 10 according to a distribution to distribution (D2D) method.

Here, the D2D method is a method of matching two different NDT maps expressed as a set of normal distributions and may be a method of matching two NDT maps by adjusting the position and direction of any one of the two NDT maps and comparing the two NDT maps.

As an example, the computing device 100 may perform localization on the autonomous driving vehicle 10 by matching a real-time 3D NDT map generated using the 3D point cloud collected in real time from the autonomous driving vehicle 10 located within a predetermined region with a previously generated low-capacity NDT map for a predetermined region through the D2D method.

For example, the computing device 100 may generate a plurality of three-dimensional grid spaces by gridding a 3D point cloud collected in real time, generate a real-time 3D NDT map including a plurality of sets of normal distributions by modeling the plurality of three-dimensional grid spaces as normal distributions, and perform localization on the autonomous driving vehicle 10 by matching the real-time 3D NDT map with the low-capacity NDT map.

In this case, the computing device 100 may generate a real-time 3D NDT map using a 3D point cloud collected in real time from the autonomous driving vehicle 10 located within a predetermined region, generate a real-time 3D NDT map for each object based on the type of an object located within the predetermined region, and perform localization on the autonomous driving vehicle 10 by matching the 3D NDT map for each object with each of a plurality of 2D NDT maps through the D2D method.

For example, the computing device 100 may extract points corresponding to a road surface from a 3D point cloud collected in real time, generate a real-time 3D NDT map corresponding to the road surface by normalizing to normal distribution the points corresponding to the road surface, and perform localization on the autonomous driving vehicle 10 by matching the real-time 3D NDT map corresponding to the road surface with the road surface NDT map, which is a low-capacity NDT map. In addition, the computing device 100 may extract points one-to-one corresponding to the first to third fixed objects from the 3D point cloud collected in real time, generate a real-time 3D NDT map corresponding to each of the first to third fixed objects by making each of the points one-to-one corresponding to the normalized to normal distribution first to third fixed objects, and perform localization on the autonomous driving vehicle 10 by matching the real-time 3D NDT map corresponding to each of the first to third fixed objects with each of the first to third fixed object NDT maps, which are low-capacity NDT maps.

As another example, the computing device 100 may perform localization on the autonomous driving vehicle 10 by matching a real-time 2D NDT map generated using the 3D point cloud collected in real time from the autonomous driving vehicle 10 located within a predetermined region with a previously generated low-capacity NDT map for the predetermined region through the D2D method. Here, a method of generating a real-time 2D NDT map using the 3D point cloud collected in real time from the autonomous driving vehicle 10 may be implemented in the same form as or a similar form to the method of generating the low-capacity NDT map according to FIG. 4, but is not limited thereto.

For example, the computing device 100 may generate a plurality of grids by gridding the 3D point cloud collected in real time based on a two-dimensional plane, model points one-to-one corresponding to the plurality of grids as a normal distribution, generate a real-time 2D NDT map by storing information about a modeled normal distribution in each of the plurality of grids, and perform localization on the autonomous driving vehicle 10 by matching the real-time 2D NDT map with a low-capacity NDT map for a predetermined region.

In this case, the computing device 100 may generate the real-time 2D NDT map using the 3D point cloud collected in real time located within the predetermined region, and may generate a real-time 2D NDT map for each object based on the type of the object located within the predetermined region, and perform localization on the autonomous driving vehicle 10 by matching the 2D NDT map for each object with each of the multiple 2D NDT maps through the D2D method.

For example, the computing device 100 may extract points corresponding to a road surface from the 3D point cloud collected in real time, generate a real-time 2D NDT map corresponding to the road surface using the points corresponding to the road surface, and perform localization on the autonomous driving vehicle 10 by matching the real-time 2D NDT map corresponding to the road surface with the road surface NDT map, which is a low-capacity NDT map. In addition, the computing device 100 may extract points one-to-one corresponding to the first to third fixed objects from the 3D point cloud collected in real time, generate a real-time 2D NDT map corresponding to each of the first to third fixed objects using the points one-to-one corresponding to the first to third fixed objects, and perform localization on the autonomous driving vehicle 10 by matching the real-time 2D NDT map corresponding to each of the first to third fixed objects with each of the first to third fixed object NDT maps, which are low-capacity NDT maps.

As described above, there is an advantage in that, by generating an NDT map for a predetermined region as a 2D (or 2.5D) NDT map instead of the commonly used 3D NDT map, the capacity of the NDT map can be drastically reduced while preventing (minimizing) degradation of the localization performance for the autonomous driving vehicle 10, thereby improving the scalability of the autonomous driving area and improving the computation speed by reducing the amount of computation.

In addition, there is an advantage in that, by separately generating an NDT map corresponding to a road surface and an NDT map corresponding to a fixed object rather than generating a single NDT map for a predetermined region, and generating an NDT map by subdividing the map according to the type of the fixed object even for the NDT map corresponding to a fixed object, the matching accuracy with the 3D point cloud collected in real time can be improved, and accordingly, more accurate localization on the autonomous driving vehicle 10 can be performed by preventing interference, noise, or errors from occurring due to dynamic objects (e.g., nearby vehicles or pedestrians) located within the predetermined region.

Furthermore, there is an advantage in that the six degrees of freedom of the autonomous driving vehicle 10 can be measured by performing localization on the autonomous driving vehicle 10 and the localization value for the autonomous driving vehicle 10 can be calculated more accurately by selectively using a specific low-capacity NDT map based on the localization value to be measured.

The method of localizing the autonomous driving using the low-capacity NDT map has been described above with reference to the flowchart illustrated in the drawings. For a simple description, the method of localizing the autonomous driving using the low-capacity NDT map has been described by illustrating it as a series of blocks, but the present invention is not limited to the order of the blocks, and some blocks may be performed in an order different from that illustrated and described in the present specification, or may be performed simultaneously. In addition, the method may be performed with new blocks not described in the present specification and drawings added, or with some blocks deleted or changed.

Although embodiments of the present invention have been described above with reference to the accompanying drawings, those skilled in the art will appreciate that the present invention may be implemented in other specific forms without changing the technical idea or essential features thereof. Therefore, it should be understood that the embodiments described above are exemplary in all respects and not restrictive.

1. A method of localizing an autonomous driving vehicle using a low-capacity normal distribution transform (NDT) map, which is performed by a computing device, the method comprising:
collecting a 3D point cloud for a predetermined region; and
performing localization on an autonomous driving vehicle using a previously generated low-capacity NDT map corresponding to the predetermined region and the collected 3D point cloud.

2. The method of claim 1, further comprising:
generating a plurality of grids by gridding the 3D point cloud corresponding to the predetermined region based on a two-dimensional plane; and
modeling points one-to-one corresponding to the plurality of generated grids as a normal distribution and generating a 2D NDT map as a low-capacity NDT map for the predetermined region by storing information about the modeled normal distribution in each of the plurality of generated grids.

3. The method of claim 2, wherein the generating of the 2D NDT map includes:
extracting a plurality of first points corresponding to a road surface from among a plurality of points included in the 3D point cloud corresponding to the predetermined region, normalizing to normal distribution the extracted plurality of first points, and generating a road surface NDT map using the plurality of normalized first points; and
extracting a plurality of second points corresponding to a fixed object from among the plurality of points included in the 3D point cloud corresponding to the predetermined region, normalizing to normal distribution the extracted plurality of second points, and generating a fixed object NDT map using the plurality of normalized second points.

4. The method of claim 3, wherein the generating of the fixed object NDT map includes:
determining a type of the fixed object located within the predetermined region based on a shape in which the plurality of extracted second points are distributed on a two-dimensional plane and classifying the plurality of extracted second points based on the determined type of the fixed object; and
generating an NDT map for each fixed object using the plurality of classified second points.

5. The method of claim 4, wherein the classifying of the plurality of extracted second points includes classifying the plurality of extracted second points as second points distributed in a point shape, second points distributed in a line shape, or second points distributed in a surface shape, and
the generating of the NDT map for each fixed object includes generating a first fixed object NDT map using the second points distributed in the point shape, generating a second fixed object NDT map using the second points distributed in the line point shape, and generating a third fixed object NDT map using the second points distributed in the surface shape.

6. The method of claim 5, wherein the generating of the 2D NDT map further includes storing the generated road surface NDT map, the generated first fixed object NDT map, the generated second fixed object NDT map, and the generated third fixed object NDT map in a form of a quad tree data structure.

7. The method of claim 2, wherein the generating of the 2D NDT includes, for a first grid and a second grid disposed at a position adjacent to the first grid among the plurality of grids included in the generated 2D NDT map, merging the first grid and the second grid into one grid when a difference between a normal distribution before merging the first grid and the second grid and the normal distribution after merging the first grid and the second grid is less than or equal to a preset threshold value.

8. The method of claim 1, wherein the previously generated low-capacity NDT map includes a plurality of 2D NDT maps for the predetermined region, the plurality of 2D NDT maps including a road surface NDT map corresponding to a road surface and one or more fixed object NDT maps corresponding to the fixed object, and
the performing of the localization on the autonomous driving vehicle includes selecting at least one 2D NDT map from among the plurality of 2D NDT maps based on a type of a localization value to be calculated for the autonomous driving vehicle, and calculating the localization value to be calculated by matching the selected at least one NDT map with the collected 3D point cloud.

9. The method of claim 8, wherein the one or more fixed object NDT maps include a first fixed object NDT map corresponding to a first fixed object having a point shape, and
the calculating of the localization value to be calculated includes matching the first fixed object NDT map with the collected 3D point cloud when the type of the localization value to be calculated is an x-axis coordinate value, a y-axis coordinate value, and a yaw value for the autonomous driving vehicle.

10. The method of claim 8, wherein the one or more fixed object NDT maps include a second fixed object NDT map corresponding to a second fixed object having a line shape, and
the calculating of the localization value to be calculated includes matching the second fixed object NDT map with the collected 3D point cloud when the type of the localization value to be calculated is a y-axis coordinate value and a yaw value or a z-axis coordinate value and a pitch value for the autonomous driving vehicle.

11. The method of claim 8, wherein the one or more fixed object NDT maps include a third fixed object NDT map corresponding to a third fixed object having a surface shape, and
the calculating of the localization value to be calculated includes matching the road surface NDT map or the third fixed object NDT map with the collected 3D point cloud when the type of the localization value to be calculated is a Z-axis coordinate value, a roll value, and a pitch value for the autonomous driving vehicle.

12. The method of claim 1, wherein the performing of the localization on the autonomous driving vehicle includes calculating a localization value for the autonomous driving vehicle by matching the 3D point cloud collected in real time from the autonomous driving vehicle located within the predetermined region with the previously generated low-capacity NDT map.

13. The method of claim 1, wherein the performing of the localization on the autonomous driving vehicle includes:
classifying a plurality of points included in the 3D point cloud collected in real time from the autonomous driving vehicle located within the predetermined region for each object; and
calculating a localization value for the autonomous driving vehicle by the plurality of points classified for each object and each previously generated low-capacity NDT map.

14. The method of claim 1, wherein the performing of the localization on the autonomous driving vehicle includes:
generating a real-time 3D NDT map by normalizing to normal distribution the 3D point cloud collected in real time from the autonomous driving vehicle located within the predetermined region; and
calculating a localization value for the autonomous driving vehicle by matching the generated real-time 3D NDT map with the previously generated low-capacity NDT map.

15. The method of claim 1, wherein the performing of the localization on the autonomous driving vehicle includes:
generating a plurality of grids by gridding the 3D point cloud collected in real time from the autonomous driving vehicle located within predetermined region based on a two-dimensional plane, modeling points one-to-one corresponding to the plurality of generated grids as a normal distribution, and generating a real-time 2D NDT map by storing information about the modeled normal distribution in each of the plurality of generated grids; and
calculating a localization value for the autonomous driving vehicle by matching the generated real-time 2D NDT map with the previously generated low-capacity NDT map.

16. A computing device for performing a method of localizing an autonomous driving system using a low-capacity normal distribution transform (NDT) map, the computing device comprising:
a processor;
a network interface;
a memory; and
a computer program loaded into the memory and executed by the processor,
wherein the computer program includes:
an instruction for collecting a 3D point cloud for a predetermined region; and
an instruction for performing localization on an autonomous driving vehicle using a previously generated NDT map corresponding to the predetermined region and the collected 3D point cloud.

17. A computing device-readable recording medium, on which a computer program coupled to the computing device to perform a method of localizing on an autonomous driving vehicle using a low-capacity normal distribution transform (NDT) map, the method including collecting a 3D point cloud for a predetermined region and performing localization on the autonomous driving vehicle using a previously generated NDT map corresponding to the predetermined region and the collected 3D point cloud.
